(19) United States
(12) Patent Application Publication
(10) Pub. No.: US 2025/0356632 A1
(43) Pub. Date: Nov. 20, 2025

(54) GLOBAL FEATURE MAP PROCESSING METHOD, IMAGE IDENTIFICATION METHOD, AND RELATED APPARATUSES

(71) Applicant: UBTECH ROBOTICS CORP LTD, Shenzhen (CN)

(72) Inventors: Kan Wang, Shenzhen (CN); Pei Dong, Shenzhen (CN); Jianxin Pang, Shenzhen (CN); Huan Tan, Shenzhen (CN)

(21) Appl. No.: 19/221,591

(22) Filed: May 29, 2025

Related U.S. Application Data
(63) Continuation of application No. PCT/CN2023/140525, filed on Dec. 21, 2023.

(30) Foreign Application Priority Data
Aug. 22, 2023 (CN) 202311064713.X

(51) Int. Cl. G06V 10/77; G06V 10/42; G06V 10/74; G06V 10/82

(52) U.S. Cl. CPC G06V 10/7715; G06V 10/42; G06V 10/761; G06V 10/82

(57) ABSTRACT

A global feature map processing method, an image identification method, and related apparatuses are provided. The method includes: obtaining a global feature map of a to-be-identified image; extracting, using a target channel attention model, low-order image information and high-order image information of the global feature map to perform a deep learning so as to obtain a low-order channel attention vector corresponding to the low-order image information and a high-order channel attention vector corresponding to the high-order image information; and obtaining an expected feature map of the to-be-identified image by performing an attention vector fusion weighted processing on the global feature map based on the low-order channel attention vector and the high-order channel attention vector. In this manner, a channel attention mechanism is introduced during the visual identification to fuse the low-order image information and high-order image information of the to-be-identified image for image feature extraction.

### CROSS REFERENCE TO RELATED APPLICATIONS

The present disclosure is a continuation-application of International Application PCT/CN2023/140525, with an international filing date of Dec. 21, 2023, which claims foreign priority to Chinese Patent Application No. 202311064713.X, filed on Aug. 22, 2023 in the State Intellectual Property Office of China, the contents of all of which are hereby incorporated by reference in its entirety.

### TECHNICAL FIELD

The present disclosure relates to image processing technology, and particularly to a global feature map processing method, an image identification method, and related apparatuses.

### BACKGROUND

With the continuous development of science and technology, image processing technology is getting widely used in video surveillance, social security and other fields. It is usually used to implement computer vision identification functions such as face recognition, pedestrian recognition, vehicle recognition, and object recognition. In the various computer vision identification functions, the accuracy of the computer vision identification function mainly depends on the quality of the image features extracted from the corresponding to-be-identified image. The better the quality of the image features extracted from the to-be-identified image, the better the accuracy of the corresponding visual identification function. Therefore, how to effectively improve the quality of the image features extracted from the to-be-identified image during the vision identification is an important technical issue in today's computer vision identification technology.

In view of this, the purpose of the present disclosure is to provide a global feature map processing method and apparatus, an image identification method and apparatus, a computer device, and a computer-readable storage medium, which can introduce a channel attention mechanism during the vision identification to fuse the low-order image information and high-order image information of the to-be-identified image so as to extract image features, thereby improve the quality of the image features extracted from the to-be-identified image.

### BRIEF DESCRIPTION OF DRAWINGS

To describe the technical schemes in the embodiments of the present disclosure or in the prior art more clearly, the following briefly introduces the drawings required for describing the embodiments or the prior art. It should be understood that, the drawings in the following description merely show some embodiments. For those skilled in the art, other drawings can be obtained according to the drawings without creative efforts.

FIG. 1 is a schematic diagram of a simplified process of extracting image features using an existing channel attention model.

FIG. 2 is a schematic diagram of the composition of a computer device according to an embodiment of the present disclosure.

FIG. 3 is a flow chart of a global feature map processing method according to an embodiment of the present disclosure.

FIG. 4 is a schematic diagram of a target channel attention model according to an embodiment of the present disclosure.

FIG. 5 is a flow chart of sub-steps of step S320 in FIG. 3.

FIG. 6 is a flow chart of sub-steps of step S330 in FIG. 3.

FIG. 7 is a flow chart of in an image identification method according to an embodiment of the present disclosure.

FIG. 8 is a schematic diagram of the composition of a global feature map processing apparatus according to an embodiment of the present disclosure.

FIG. 9 is a schematic diagram of the composition of an image identification apparatus according to an embodiment of the present disclosure.

### DETAILED DESCRIPTION

In order to make the objects of the embodiments of the present disclosure more clear, the technical solutions in the embodiments of the present disclosure will be clearly and completely described below with reference to the drawings in the embodiments of the present disclosure. Apparently, the described embodiments are part of the embodiments of the present disclosure, not all of the embodiments. The components of the embodiments of the present disclosure that are described and illustrated in the drawings herein may generally be arrent and designed in a variety of different configurations.

Therefore, the following detailed description of the embodiments of the present disclosure provided in the drawings is not intended to limit the scope of the present disclosure, but merely represent the selected embodiments of the present disclosure. Based on the embodiments in the present disclosure, all other embodiments obtained by those skilled in the art without creative work are within the scope of the present disclosure.

It should be noted that similar reference numerals and letters denote similar items in the following drawings, and therefore, once an item is defined in one drawing, it will not be further defined or explained in subsequent drawings.

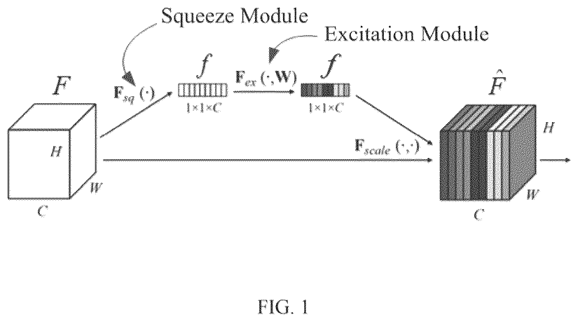

In the description of present disclosure, it should be noted that relational terms such as “first” and “second” are used only to distinguish one entity or operation from another entity or operation, and do not necessarily require or imply the existence of any actual relationship or sequence between these entities or operations. Moreover, the terms “comprising”, “including” or any other variation thereof are intended to encompass non-exclusive inclusion such that a process, method, article or apparatus (device) comprising a series of elements includes not only those elements, but also includes other elements not explicitly listed or inherent to the process, method, article or apparatus. Without further limitation, an element limited by the sentence “comprising a . . . ” does not preclude the existence of additional identical elements in a process, method, article or apparatus that includes the element. For those of ordinary skill in the art, the specific meanings of the above-mentioned terms in the present disclosure can be understood according to the specific condition. The inventor has found through unremitting researches that the currently implemented schemes for improving the quality of the extracted image features of the to-be-identified images usually adopt the channel attention mechanism to obtain low-order image information of the to-be-identified image for extracting image features. FIG. 1 is a schematic diagram of a simplified process of extracting image features using an existing channel attention model. As shown in FIG. 1, in the currently implemented scheme, it needs to use a deep learning model to extract a global feature map of the to-be-identified image (i.e., the global feature map F∈R^{C×H×W} in FIG. 1, where C, H, and W represent the number of channels, the height, and the width of the global feature map, respectively), and then input the global feature map of the to-be-identified image into the existing channel attention model. In such a manner, the squeeze module in the existing channel attention model will perform a “compression” operation (i.e., performing a global average pooling processing represented by F on the global feature map) on the global feature map at the level of spatial dimension, and then the excitation module in the existing channel attention model will perform a “purification” operation (i.e., using two fully connected layers with their respective corresponding activation functions to continuously perform “dimensionality augmentation” and “dimensionality reduction” represented by Fₑₓ on the above-mentioned initial channel attention vector) on the above-mentioned initial channel attention vector at the level of channel dimension to obtain a low-order channel attention vector \hat{f} carrying low-order image information (i.e., first-order image information) of the to-be-identified image. Then, by performing channel-by-channel multiplication (i.e., F_{scale} operation in FIG. 1) on the low-order channel attention vector and the global feature map, it eventually obtains the feature map (i.e., the feature map \hat{F}∈R^{C×H×W} in FIG. 1) of the to-be-identified image that carries the low-order image information, thereby improving the quality of the extracted image features of the to-be-identified image.

In this process, the equation for calculating the above-mentioned initial channel attention vector under the “purification” operation may be expressed as an equation of:

$$f = \frac{1}{H \times W} {\sum }_{h = 1}^{H} {\sum }_{w = 1}^{W} {F}_{h , w} ;$$

The actual calculation of the above-mentioned low-order channel attention vector under the “purification” operation may be expressed as an equation of:

$$\hat{f} = σ {W}_{2} δ ( {W}_{1} f ) ;$$

where, f represents the initial channel attention vector, F_{h,w} represents the image features of the global feature map of the to-be-identified image at the level of space dimension H×W, \hat{f} represents the low-order channel attention vector, W₁ represents the fully connected layer that realizes “dimensionality reduction”, δ represents the activation function (i.e., ReLU function) that realizes “dimensionality augmentation”, W₂ represents the fully connected layer that realizes “dimensionality reduction”, and σ represents the activation function (i.e., Sigmoid function) that realizes “dimensionality reduction”.

It is worth noting that this implementation can only ensure that the extracted feature map of the to-be-identified image carries the low-order image information, resulting in the image feature information of the corresponding extracted feature map being still not rich enough to effectively improve the quality of the image features extracted from the to-be-identified image, let alone improve the identification accuracy of the image identification function.

In this case, in order to address the foregoing issues, the embodiments of the present disclosure provide a global feature map processing method and apparatus, an image identification method and apparatus, a computer device, and a computer-readable storage medium, which can introduce the channel attention mechanism during the visual identification to fuse the low-order image information and high-order image information of the to-be-identified image for image feature extraction, thereby improving the quality of the image features extracted from the to-be-identified image, ensuring that the image features extracted from the corresponding to-be-identified image have good robustness and identifiability, and simultaneously improving the identification accuracy of the visual identification function.

Some embodiments of the present disclosure will be described in detail below with reference to the drawings. The following embodiments and the features therein may be combined with each other while there is no confliction therebetween.

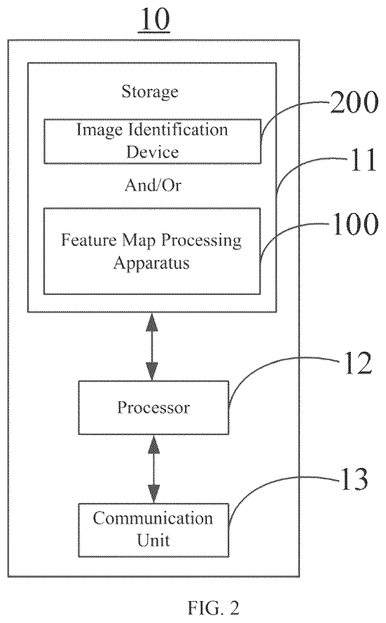

FIG. 2 is a schematic diagram of the composition of a computer device 10 according to an embodiment of the present disclosure. As shown in FIG. 2, in this embodiment, the computer device 10 may be installed with a deep neural network model, and a visual identification function may be realized through the deep neural network model, where the visual identification function may be any image identification function like face identification function, pedestrian identification function, vehicle identification function, and object identification function. The computer device 10 may be, for example, a smart phone, a robot, a notebook computer, a personal computer, a server, or the like.

In the embodiments of the present disclosure, the computer device 10 may include a storage 11, a processor 12, and a communication unit 13. In which, the storage 11, are directly or indirectly electronically connected to each part of the processor 12 and the communication unit 13 to realize data transmission or interactions. For example, the storage 11, the components 12 and the communication unit 13 may be electrically connected to each other through one or more communication buses or signal lines.

In this embodiment, the storage 11 may be, but not limited to, a random access memory (RAM), a read only memory (ROM), a programmable read only memory (PROM), erasable programmable read-Only memory (EPROM), electrical erasable programmable read-only memory (EEPROM), or the like. In which, the storage 11 is used for storing computer programs, and the processor 12 can execute the computer programs correspondingly after receiving execution instructions.

In this embodiment, the processor 12 may be an integrated circuit chip with signal processing capability. The processor 12 may be a general purpose processor including at least one of a central processing unit (CPU), a graphics processing unit (GPU), a network processor (NP), a digital signal processor (DSP), an application specific integrated circuit (ASIC), a field-programmable gate array (FPGA) or other programmable logic devices, discrete gate, transistor logic device, and discrete hardware component. The general purpose processor may be a microprocessor or the processor may also be any conventional processor that may implement or execute the methods, steps, and the logical block diagrams disclosed in the embodiments of the present disclosure.

In this embodiment, the communication unit 13 may be used for establishing a communication connection between the computer device 10 and other electronic devices through a network, and for sending/receiving data through the network, where the network may include a wired communication and a wireless communication network. For example, the computer device 10 may obtain the to-be-identified images uploaded by other electronic devices through the communication unit 13, where the apparatus 13 may be a surveillance device, a camera, or the like.

As an example, in the embodiments of the present disclosure, the deep neural network model installed in the computer device 10 may be embedded with a target channel attention model, and the computer device 10 may further include a feature map processing apparatus 100. The feature map processing apparatus 100 may include at least one software function module that may be stored in the storage 11 in the form of software or firmware, or be fixed in the operating system of the computer device 10. The processor 12 may be configured to execute the executable modules stored in the storage 11, for example, the software function module, the computer programs, and the like included in the feature map processing apparatus 100. The computer device 10 may use, through the feature map processing apparatus 100, the target channel attention model to introduce a channel attention mechanism during the visual identification to fuse the low-order image information and high-order image information of the to-be-identified image for image feature extraction, thereby improving the quality of the image features extracted from the to-be-identified image, thereby ensuring that the image features extracted from the corresponding to-be-identified image have good robustness and identifiability, and simultaneously improving the identification accuracy of the visual identification function.

As an example, in this embodiment, the computer device 10 may further include an image identification device 200. The image identification device 200 may include at least one software function module that may be stored in the storage 11 or filtered in the operation system of the computer device 10 in the form of software or feature. The processor 12 may be used to execute the executable modules stored in the storage 11, for example, software function modules and computer programs included in the image identification device 200. The computer device 10 may improve the accuracy of the vision image identification functions by using the target channel attention model through the image identification device 200.

It should be noted that the block diagram shown in FIG. 2 is only an example of the structure of the computer device 10, and the computer device 1 10 may also include more or fewer components than that shown in FIG. 2, or have a different configuration from that shown in FIG. 2. Each of the components shown in FIG. 2 may be implemented in hardware, software or a combination thereof.

In the present disclosure, in order to ensure that the computer device 10 can introduce the channel attention mechanism during the visual identification to fuse the low-order image information and high-order image information of the to-be-identified image for image feature extraction, thereby improving the quality of the image features extracted from the to-be-identified image, ensuring that the image features extracted from the corresponding to-be-identified image have good robustness and identifiability, and simultaneously improving the identification accuracy of the visual identification function, the embodiments of the present disclosure provide a feature map processing method accordingly. The provided feature map processing method will be described in detail below.

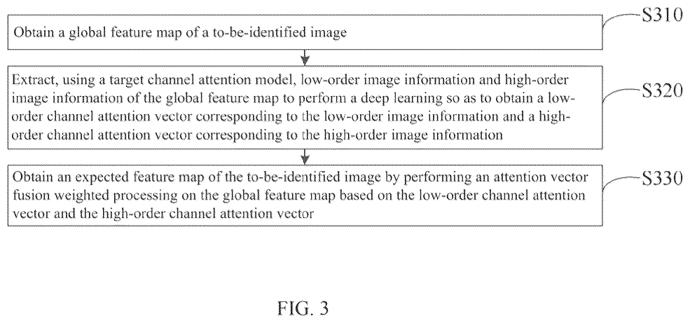

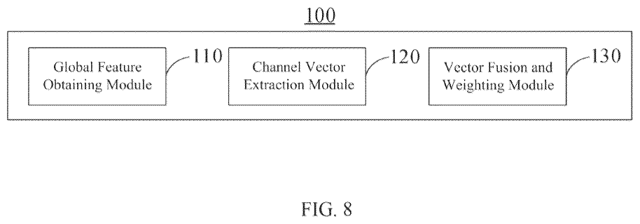

FIG. 3 is a flow chart of a global feature map processing method according to an embodiment of the present disclosure. In this embodiment, the feature map processing method may be applied to (a processor of) an electronic device implementing image identification for, for example, achieving automatic navigation. If the electronic device is, for example, a humanoid robot including a head part, a camera disposed on the head part may be used to capture the to-be-identified images for image identification. In other embodiments, the method may be implemented through the computer device 10 as shown in FIG. 2 or the feature map processing apparatus 100 as shown in FIG. 8. As shown in FIG. 3, the feature map processing method may include the following steps.

S310: obtaining a global feature map of a to-be-identified image.

In this embodiment, the computer device 10 may input the to-be-identified image into a deep neural network model installed in its system, so as to extract the global feature map of the to-be-identified image through the deep neural network model.

S320: extracting, using a target channel attention model, low-order image information and high-order image information of the global feature map to perform a deep learning so as to obtain a low-order channel attention vector corresponding to the low-order image information and a high-order channel attention vector corresponding to the high-order image information.

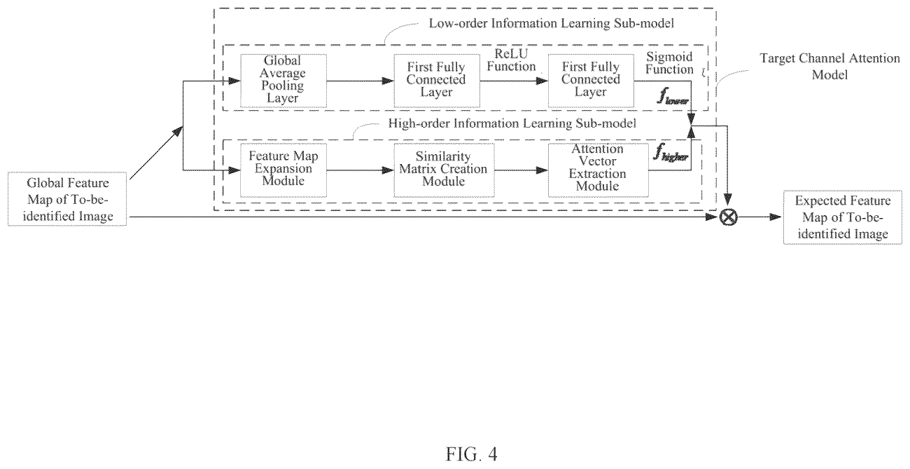

FIG. 4 is a schematic diagram of a target channel attention model according to an embodiment of the present disclosure. As shown in FIG. 4, in this embodiment, the target channel attention model may include a low-order information learning sub-model and a high-order information learning sub-model, where the low-order information learning sub-model is for extracting the low-order image information of the global feature map of the to-be-identified image for deep learning to output the low-order channel attention vector corresponding to the low-order image information; the high-order information learning sub-model is for extracting the high-order image information of the global feature map of the to-be-identified image for deep learning to output the high-order channel attention vector corresponding to the high-order image information.

In which, the low-order information learning sub-model may include a global average pooling layer, a first fully connected layer and a second fully connected layer connected in sequence, a ReLU function is used as an activation function between the first fully connected layer and the second fully connected layer, and a Sigmoid function is used as an activation function at an output end of the second fully connected layer, by which to ensure that the low-order information learning sub-model can extract the first-order image information of the global feature map of the to-be-identified image to use as the low-order image information for deep learning.

In which, the high-order information learning sub-model may include a feature map expansion module, a similarity matrix creation module and an attention vector extraction module connected in sequence, by which to ensure that the high-order information learning sub-model can extract the second-order image information of the global feature map of the to-be-identified image as the high-order image information for deep learning.

In this case, after obtaining the global feature map of the to-be-identified image, the computer device 10 may synchronously input the global feature map into the low-order information learning sub-model and the high-order information learning sub-model of the target channel attention model, and drive the low-order information learning sub-model and the high-order information learning sub-model to perform deep learning respectively, so as to obtain the low-order channel attention vector carrying the low-order image information of the to-be-identified image, and the high-order channel attention vector carrying the high-order image information of the to-be-identified image, where the target channel attention model is embedded in the neural learning network model installed in the computer device 10.

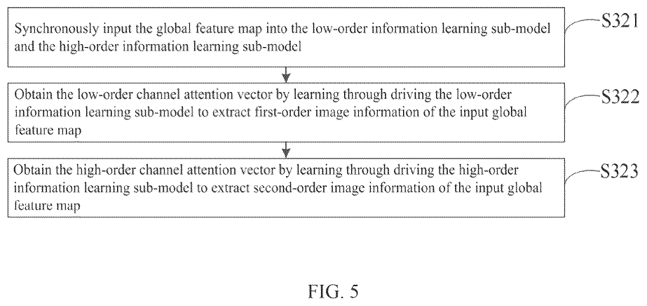

FIG. 5 is a flow chart of sub-steps of step S320 in FIG. 3. As shown in FIG. 5, in this embodiment, step S320 may include sub-steps S321-S323 to ensure that the target channel attention model can extract the low-order image information and the high-order image information of the to-be-identified image to create the corresponding channel attention vectors respectively.

S321: synchronously inputting the global feature map into the low-order information learning sub-model and the high-order information learning sub-model.

S322: obtaining the low-order channel attention vector by learning through driving the low-order information learning sub-model to extract first-order image information of the input global feature map.

In this embodiment, in sub-step S322, the computer device 10 drives the low-order information learning sub-model to extract the first-order image information of the global feature map to obtain the low-order channel attention vector may include:

a: performing, by using the global average pooling layer, a feature map compression processing on the global feature map at the level of spatial dimension to obtain an initial channel attention vector of the global feature map.

In which, the initial channel attention vector of the global feature map may be calculated through an equation of:

$$f = \frac{1}{H \times W} {\sum }_{h = 1}^{H} {\sum }_{w = 1}^{W} {F}_{h , w} ;$$

where, f represents the initial channel attention vector, and F_{h,w} represents the image features of the global feature map of the to-be-identified image at the level of space dimension H×W.

b: performing, by using the first fully connected layer and the ReLU function, a vector dimension incretion processing on the initial channel attention vector at the level of channel dimension level to obtain an intermediate channel attention vector.

In which, the intermediate channel attention vector may be calculated through an equation of:

$${\hat{f}}_{1} = δ ( {W}_{1} f ) ;$$

where, f represents the initial channel attention vector, \hat{f}₁ represents the intermediate channel attention vector, W₁ represents the first fully connected layer, and δ represents the ReLU function.

c: performing, by using the second fully connected layer and the Sigmoid function, a vector dimension reduction processing on the intermediate channel attention vector at the level of channel dimension to obtain the low-order channel attention vector.

In which, the low-order channel attention vector may be calculated through an equation of:

$${f}_{lower} = σ {W}_{2} ( {\hat{f}}_{1} ) ;$$

where, f_{lower} represents the low-order channel attention vector, \hat{f}₁ represents the intermediate channel attention vector, W₂ represents the second fully connected layer, and θ represents the Sigmoid function.

Therefore, in this embodiment, by performing the above-mentioned sub-steps a-c, it can ensure that the target channel attention model to use the low-order information learning sub-model to extract the low-order image information of the to-be-identified image for constructing the corresponding channel attention vector.

S323: obtaining the high-order channel attention vector by learning through driving the high-order information learning sub-model to extract second-order image information of the input global feature map.

In this embodiment, in sub-step S323, the computer device 10 dries the high-order information learning sub-model to extract the second-order image information of the global feature map to obtain the high-order channel attention vector may include:

e: performing, by using the feature map expansion module, a feature map expansion processing on the global feature map along a direction of channel dimension to obtain a two-dimensional feature matrix corresponding to the global feature map at channel dimension.

In which, if the global feature map is represented by F∈R^{C×H×W}, then its corresponding two-dimensional feature matrix at the level of channel dimension may be expressed as F^{R}∈R^{C×(HW)}, and each row matrix vector of the two-dimensional feature matrix is used to represent the image features of the global feature map in the corresponding channel, for example, the corresponding matrix vector Fₖ^{R} of the two-dimensional feature matrix at the k-th row is for representing the image features of the global feature map at the channel corresponding to the k-th row. The length of the image features of each row matrix vector in the same two-dimensional feature matrix is HW.

f: calculating, by using the similarity matrix creation module, a vector similarity between row matrix vectors of the two-dimensional feature matrix, and performing a matrix construction based on all the calculated vector similarities to obtain a feature similarity matrix of the global feature map at channel dimension.

In which, the vector similarity between the i-th-row matrix vector and the j-th row matrix vector in the two-dimensional feature matrix may be used as the value of the matrix element of the feature similarity matrix in the i-th row and the j-column. At this time, the feature similarity matrix is a C×C matrix with differential line element of 1, where the vector similarity between the i-row matrix vector and the j-row matrix vector may be calculated using an equation of:

$${S}_{i , j} = \frac{{F}_{i}^{R} \cdot {F}_{j}^{R}}{‖ {F}_{i}^{R} ‖ ‖ {F}_{j}^{R} ‖} ;$$

where, S, represents the value of the matrix element of the feature similarity matrix in the i-th row and the j-th column,

$${F}_{i}^{R}$$

represents the i-row matrix vector in the two-dimensional feature matrix,

$${F}_{j}^{R}$$

represents the j-row matrix vector in the two-dimensional feature matrix, and represents a two-norm calculation.

g: performing, by using the attention vector extraction module, an element mean operation on each column matrix vector of the feature similarity matrix to obtain the high-order channel attention vector composed of an actual element mean of the column matrix vector.

In which, it may calculate the mean of all the matrix elements in the same column of the matrix vector in the feature similarity matrix, and use the calculated actual element mean as a corresponding vector element value of the column matrix vector in the high-order channel attention vector f_{higher}. At this time, the value of the i-th vector element in the high-order channel attention vector f_{higher} is the actual element mean of all the matrix elements at the i-th column of the matrix vector of the feature similarity matrix.

In this embodiment, by performing the foregoing sub-steps e-g, it can ensure that the target channel attention model can use the high-order information learning sub-model to extract the high-order image information of the to-be-identified image to construct the corresponding channel attention vector.

In this embodiment, by performing the foregoing sub-steps S321-S323, it can ensure that the target channel attention model can extract the low-order image information and high-order image information of the to-be-identified image to construct the corresponding channel attention vectors, respectively.

S330: obtaining an expected feature map of the to-be-identified image by performing an attention vector fusion weighted processing on the global feature map based on the low-order channel attention vector and the high-order channel attention vector.

In this embodiment, in the case that the computer device 10 obtains the low-order channel attention vector carrying the low-order image information of the to-be-identified image and the high-order channel attention vector carrying the high-order image information of the to-be-identified image, it will fuse the attention vectors of the low-order channel attention vector and the high-order channel attention vector and use the fused channel attention vector to perform weighted processing on the global feature map of the to-be-identified image, thereby obtaining the expected feature map with high image feature quality to ensure that the image features extracted from the corresponding to-be-identified image have good robustness and identifiability, and simultaneously improving the identification accuracy of the visual identification function.

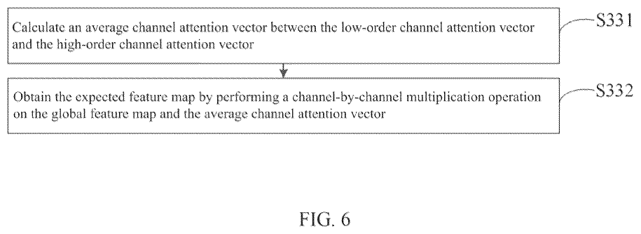

FIG. 6 is a flow chart of sub-steps of step S330 in FIG. 3. As shown in FIG. 6, in this embodiment, step S330 may include sub-steps S331-S332 to ensure that the image features extracted from the to-be-identified image can fuse the low-order image information and high-order image information, thereby ensuring that the corresponding image features have good robustness and identifiability, and simultaneously improving the identification accuracy of the visual identification function.

S331: calculating an average channel attention vector between the low-order channel attention vector and the high-order channel attention vector.

In which, the average channel attention vector may be expressed as 0.5*(low-order channel attention vector f_{lower}+high-order channel attention vector f_{higher})

S332: obtaining the expected feature map by performing a channel-by-channel multiplication operation on the global feature map and the average channel attention vector.

In which, the channel-by-channel multiplication effect can be achieved by performing a Kronecker product operation on the global feature map and the average channel attention vector, thereby ensuring that the image features of the expected feature map substantially fuse the low-order image information and high-order image information, ensuring that the corresponding image features have good robustness and identifiability, and simultaneously improving the identification accuracy of the visual identification function.

Therefore, in this embodiment, by performing the foregoing sub-steps S331-S333, it can ensure that the image features extracted from the to-be-identified image can integrate the low-order image information and high-order image information to ensure that the corresponding image features have good robustness and identifiability, and simultaneously improve the identification accuracy of the visual identification function.

In this embodiment, by performing the foregoing steps S310-S330, the channel attention mechanism is introduce during the visual identification to fuse the low-order image information and high-order image information of the to-be-identified image for image feature extraction, thereby improving the quality of the image features extracted from the to-be-identified image, ensuring that the image features extracted from the corresponding to-be-identified image have good robustness and identifiability, and simultaneously improving the identification accuracy of the visual identification function.

In the embodiments of the present disclosure, in order to ensure that the computer device 10 can effectively improve the identification accuracy of the visual identification function while implementing the visual identification function, an image identification method is provided. The provided image identification method will be described in detail below.

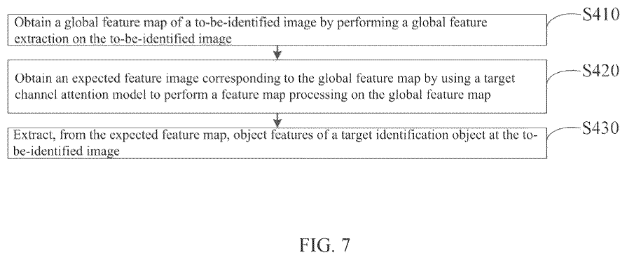

FIG. 7 is a flow chart of in an image identification method according to an embodiment of the present disclosure. In this embodiment, the image identification method may include steps S410-S430.

S410: obtaining a global feature map of the to-be-identified image by performing a global feature extraction on the to-be-identified image;

In this embodiment, the computer device 10 may input the to-be-identified image into the deep neural network model carried by itself, thereby extracting the global feature map of the to-be-identified image through the deep neural network model.

S420: obtaining an expected feature image corresponding to the global feature map by using a target channel attention model to perform a feature map processing on the global feature map.

In which, the expected feature map is obtained by processing the above-mentioned feature map processing method to introduce the channel attention mechanism is during the visual identification to fuse the low-order image information and high-order image information of the to-be-identified image for image feature extraction so as to ensure that the image feature quality of the expected feature map is high enough, thereby ensuring that the quality of the image features of the expected feature map have good robustness and identifiability.

S430: extracting, from the expected feature map, object features of a target identification object at the to-be-identified image.

In which, the target identification object is the object for which the visual identification function that the image identification method expects to achieve. Taking the visual identification function like “vehicle identification function” as an example, its corresponding target identification object is a vehicle like a bicycle, a motorcycle, an electric bike, a car, or the like.

Therefore, in this embodiment, by performing the foregoing steps 410-S430, it can effectively improve the identification accuracy of the visual identification function while implementing the visual identification function.

In the present disclosure, in order to ensure that the computer device 10 can perform the above-mentioned feature map processing method effectively, the above-mentioned functions are implemented by dividing the functional modules of the feature map processing apparatus 100 stored in the computer device 10. The specific components of the feature map processing apparatus 100 applied to the above-mentioned computer device 10 will be described accordingly below.

FIG. 8 is a schematic diagram of the composition of the global feature map processing apparatus 100 according to an embodiment of the present disclosure. As shown in FIG. 8, in this embodiment, the feature map processing apparatus 100 may include a global feature obtaining module 110, a channel vector extraction module 120, and a vector fusion and weighting module 130. In which:

the global feature obtaining module 110 is configured to obtain a global feature map of a to-be-identified image;

the channel vector extraction module 120 is configured to extract, using a target channel attention model, low-order image information and high-order image information of the global feature map to perform a deep learning so as to obtain a low-order channel attention vector corresponding to the low-order image information and a high-order channel attention vector corresponding to the high-order image information; and

the vector fusion and weighting module 130 is configured to obtain an expected feature map of the to-be-identified image by performing an attention vector fusion weighted processing on the global feature map based on the low-order channel attention vector and the high-order channel attention vector.

It should be noted that, in this embodiment, the feature map processing apparatus 100 has the same basic principles and technical effects as the above-mentioned feature map processing method. For a brief description of the parts not mentioned in this embodiment, reference may be made to the foregoing description of the feature map processing method.

In the present disclosure, in order to ensure that the computer device 10 can perform the above-mentioned image identification method effectively, the above-mentioned functions are implemented by dividing the functional modules of an image identification apparatus 200 stored in the computer device 10. The specific components of the image identification apparatus 200 applied to the above-mentioned computer device 10 will be described accordingly below.

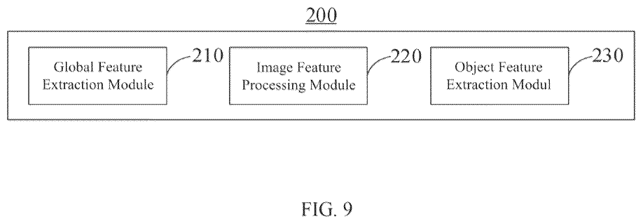

FIG. 9 is a schematic diagram of the composition of the image identification apparatus 200 according to an embodiment of the present disclosure. As shown in FIG. 9, in this embodiment, the image identification apparatus 200 may include the global feature extraction module 210, the image feature processing module 220, and the object feature extraction module 230. In which:

the global feature obtaining module 210 is configured to obtain a global feature map of the to-be-identified image by performing a global feature extraction on the to-be-identified image;

the image feature processing module 220 is configured to obtain an expected feature map corresponding to the global feature map by using a target channel attention model to perform a feature map processing on the global feature map, where the image feature processing module 220 may obtain the expected feature map of the to-be-identified image by performing a feature processing method using the feature map processing apparatus 100; and

the object feature extraction 230 is configured to extract, from the expected feature map, object features of a target identification object at the to-be-identified image.

It should be noted that, the image identification device 200 provided by this embodiment has the same basic principles and technical effects as the above-mentioned image identification method. For a brief description, for parts not mentioned in this embodiment, reference may be made to the forgoing description of the image identification method.

In the embodiments of the present disclosure, it should be understood that the disclosed apparatus and method may be implemented in other manners. The above-mentioned apparatus embodiment is merely illustrative, for example, the flow charts and block diagrams in the drawings show the architecture, functions and operations that are possible to be implemented by the apparatus, method and computer program products of the embodiments. In this regard, each block in the flowchart or block diagram may represent a module, a program segment, or a part of codes that include one or more computer executable instructions for implementing specified logical functions. It should also be noted that, in some alternative implementations, the functions noted in the blocks may occur out of the order noted in the figures. For example, two blocks in succession may, in fact, be executed substantially concurrently, or may sometimes be executed in the reverse order, depending upon the functionality involved. It is also to be noted that each block in the block diagrams and/or flow charts, and the combination of blocks in the block diagrams and/or flow charts, may be implemented by a dedicated hardware-based system for performing the specified function or action, or may be implemented by a combination of special purpose hardware and computer instructions.

In addition, each functional module or unit in each embodiment of the present disclosure may be integrated to form an independent part, each module or unit may exist independently, or two or more modules or units may be integrated to form an independent part. Various functions provided by the embodiments of the present disclosure may be stored in a computer-readable storage medium if it is implemented in the form of a software functional unit and sold or utilized as a separate product. Based on this understanding, the technical solution of the present disclosure, either essentially or in part, contributes to the prior art, or a part of the technical solution can be embodied in the form of a software product. The software product is stored in a storage medium, which includes a number of instructions for enabling a computer device (which can be a personal computer, a server, a network device, etc.) to execute all or a part of the steps of the methods described in each of the embodiments of the present disclosure. The above-mentioned storage medium includes a variety of media such as a USB disk, a mobile hard disk, a read-only memory (ROM), a random access memory (RAM), a magnetic disk, and an optical disk which is capable of storing program codes.

In summary, in the global feature map processing method and apparatus, the image identification method and apparatus, the computer device, and the computer-readable storage medium of the embodiments of the present disclosure, by obtaining a global feature map of a to-be-identified image; extracting, using a target channel attention model, low-order image information and high-order image information of the global feature map to perform a deep learning so as to obtain a low-order channel attention vector corresponding to the low-order image information and a high-order channel attention vector corresponding to the high-order image information; and obtaining an expected feature map of the to-be-identified image by performing an attention vector fusion weighted processing on the global feature map based on the low-order channel attention vector and the high-order channel attention vector, a channel attention mechanism is introduced during the visual identification to fuse the low-order image information and high-order image information of the to-be-identified image for image feature extraction, thereby improving the quality of the image features extracted from the to-be-recognized image.

The forgoing is only various embodiments of the present disclosure, while the scope of the present disclosure is not limited thereto. For those skilled in the art, modifications or replacements that may be easily conceived within the technical scope of the present disclosure should be included within the scope of the present disclosure. Therefore, the scope of the present disclosure should be according to the scope of the claims.

What is claimed is:

1. A method for processing a global feature map, comprising:
obtaining the global feature map of a to-be-identified image;
extracting, using a target channel attention model, low-order image information and high-order image information of the global feature map to perform a deep learning so as to obtain a low-order channel attention vector corresponding to the low-order image information and a high-order channel attention vector corresponding to the high-order image information; and
obtaining an expected feature map of the to-be-identified image by performing an attention vector fusion weighted processing on the global feature map based on the low-order channel attention vector and the high-order channel attention vector.

2. The method of claim 1, wherein the target channel attention model includes a low-order information learning sub-model and a high-order information learning sub-model; and wherein extracting, using the target channel attention model, low-order image information and high-order image information of the global feature map to perform the deep learning so as to obtain the low-order channel attention vector corresponding to the low-order image information and the high-order channel attention vector corresponding to the high-order image information comprises:
synchronously inputting the global feature map into the low-order information learning sub-model and the high-order information learning sub-model;
obtaining the low-order channel attention vector by learning through driving the low-order information learning sub-model to extract first-order image information of the input global feature map; and
obtaining the high-order channel attention vector by learning through driving the high-order information learning sub-model to extract second-order image information of the input global feature map.

3. The method of claim 2, wherein the low-order information learning sub-model includes a global average pooling layer, a first fully connected layer and a second fully connected layer connected in sequence, and a ReLU function is used as an activation function between the first fully connected layer and the second fully connected layer, and a Sigmoid function is used as an activation function at an output end of the second fully connected layer; and wherein obtaining the low-order channel attention vector by learning through driving the low-order information learning sub-model to extract first-order image information of the input global feature map comprises:
performing, by using the global average pooling layer, a feature map compression processing on the global feature map at spatial dimension to obtain an initial channel attention vector of the global feature map;
performing, by using the first fully connected layer and the ReLU function, a vector dimension incretion processing on the initial channel attention vector at channel dimension to obtain an intermediate channel attention vector; and
performing, by using the second fully connected layer and the Sigmoid function, a vector dimension reduction processing on the intermediate channel attention vector at channel dimension to obtain the low-order channel attention vector.

4. The method of claim 2, wherein the high-order information learning sub-model includes a feature map expansion module, a similarity matrix creation module and an attention vector extraction module connected in sequence; and wherein obtaining the high-order channel attention vector by learning through driving the high-order information learning sub-model to extract second-order image information of the input global feature map comprises:
performing, by using the feature map expansion module, a feature map expansion processing on the global feature map along a direction of channel dimension to obtain a two-dimensional feature matrix corresponding to the global feature map at channel dimension, wherein each row matrix vector of the two-dimensional feature matrix is for representing image features of the global feature map at a corresponding channel;
calculating, by using the similarity matrix creation module, a vector similarity between row matrix vectors of the two-dimensional feature matrix, and performing a matrix construction based on all the calculated vector similarities to obtain a feature similarity matrix of the global feature map at channel dimension; and
performing, by using the attention vector extraction module, an element mean operation on each column matrix vector of the feature similarity matrix to obtain the high-order channel attention vector composed of an actual element mean of the column matrix vector.

5. The method of claim 1, wherein obtaining the expected feature map of the to-be-identified image by performing the attention vector fusion weighted processing on the global feature map based on the low-order channel attention vector and the high-order channel attention vector comprises:
calculating an average channel attention vector between the low-order channel attention vector and the high-order channel attention vector; and
obtaining the expected feature map by performing a channel-by-channel multiplication operation on the global feature map and the average channel attention vector.

6. A method for recognizing a to-be-identified image, comprising:
obtaining a global feature map of the to-be-identified image by performing a global feature extraction on the to-be-identified image;
extracting, using a target channel attention model, low-order image information and high-order image information of the global feature map to perform a deep learning so as to obtain a low-order channel attention vector corresponding to the low-order image information and a high-order channel attention vector corresponding to the high-order image information;
obtaining an expected feature map of the to-be-identified image by performing an attention vector fusion weighted processing on the global feature map based on the low-order channel attention vector and the high-order channel attention vector; and
extracting, from the expected feature map, object features of a target identification object at the to-be-identified image.

7. The method of claim 6, wherein the target channel attention model includes a low-order information learning sub-model and a high-order information learning sub-model; and wherein extracting, using the target channel attention model, low-order image information and high-order image information of the global feature map to perform the deep learning so as to obtain the low-order channel attention vector corresponding to the low-order image information and the high-order channel attention vector corresponding to the high-order image information comprises:
synchronously inputting the global feature map into the low-order information learning sub-model and the high-order information learning sub-model;
obtaining the low-order channel attention vector by learning through driving the low-order information learning sub-model to extract first-order image information of the input global feature map; and
obtaining the high-order channel attention vector by learning through driving the high-order information learning sub-model to extract second-order image information of the input global feature map.

8. The method of claim 7, wherein the low-order information learning sub-model includes a global average pooling layer, a first fully connected layer and a second fully connected layer connected in sequence, and a ReLU function is used as an activation function between the first fully connected layer and the second fully connected layer, and a Sigmoid function is used as an activation function at an output end of the second fully connected layer; and wherein obtaining the low-order channel attention vector by learning through driving the low-order information learning sub-model to extract first-order image information of the input global feature map comprises:
performing, by using the global average pooling layer, a feature map compression processing on the global feature map at spatial dimension to obtain an initial channel attention vector of the global feature map;
performing, by using the first fully connected layer and the ReLU function, a vector dimension incretion processing on the initial channel attention vector at channel dimension to obtain an intermediate channel attention vector; and
performing, by using the second fully connected layer and the Sigmoid function, a vector dimension reduction processing on the intermediate channel attention vector at channel dimension to obtain the low-order channel attention vector.

9. The method of claim 7, wherein the high-order information learning sub-model includes a feature map expansion module, a similarity matrix creation module and an attention vector extraction module connected in sequence; and wherein obtaining the high-order channel attention vector by learning through driving the high-order information learning sub-model to extract second-order image information of the input global feature map comprises:
performing, by using the feature map expansion module, a feature map expansion processing on the global feature map along a direction of channel dimension to obtain a two-dimensional feature matrix corresponding to the global feature map at channel dimension, wherein each row matrix vector of the two-dimensional feature matrix is for representing image features of the global feature map at a corresponding channel;
calculating, by using the similarity matrix creation module, a vector similarity between row matrix vectors of the two-dimensional feature matrix, and performing a matrix construction based on all the calculated vector similarities to obtain a feature similarity matrix of the global feature map at channel dimension; and
performing, by using the attention vector extraction module, an element mean operation on each column matrix vector of the feature similarity matrix to obtain the high-order channel attention vector composed of an actual element mean of the column matrix vector.

10. The method of claim 6, wherein obtaining the expected feature map of the to-be-identified image by performing the attention vector fusion weighted processing on the global feature map based on the low-order channel attention vector and the high-order channel attention vector comprises:
calculating an average channel attention vector between the low-order channel attention vector and the high-order channel attention vector; and
obtaining the expected feature map by performing a channel-by-channel multiplication operation on the global feature map and the average channel attention vector.

11. A non-transitory computer-readable storage medium for storing one or more computer programs, wherein the one or more computer programs comprise:
instructions for obtaining a global feature map of a to-be-identified image;
instructions for extracting, using a target channel attention model, low-order image information and high-order image information of the global feature map to perform a deep learning so as to obtain a low-order channel attention vector corresponding to the low-order image information and a high-order channel attention vector corresponding to the high-order image information; and
instructions for obtaining an expected feature map of the to-be-identified image by performing an attention vector fusion weighted processing on the global feature map based on the low-order channel attention vector and the high-order channel attention vector.

12. The storage medium of claim 11, wherein the target channel attention model includes a low-order information learning sub-model and a high-order information learning sub-model; and wherein extracting, using the target channel attention model, low-order image information and high-order image information of the global feature map to perform the deep learning so as to obtain the low-order channel attention vector corresponding to the low-order image information and the high-order channel attention vector corresponding to the high-order image information comprises:
synchronously inputting the global feature map into the low-order information learning sub-model and the high-order information learning sub-model;
obtaining the low-order channel attention vector by learning through driving the low-order information learning sub-model to extract first-order image information of the input global feature map; and
obtaining the high-order channel attention vector by learning through driving the high-order information learning sub-model to extract second-order image information of the input global feature map.

13. The storage medium of claim 12, wherein the low-order information learning sub-model includes a global average pooling layer, a first fully connected layer and a second fully connected layer connected in sequence, and a ReLU function is used as an activation function between the first fully connected layer and the second fully connected layer, and a Sigmoid function is used as an activation function at an output end of the second fully connected layer; and wherein obtaining the low-order channel attention vector by learning through driving the low-order information learning sub-model to extract first-order image information of the input global feature map comprises:
performing, by using the global average pooling layer, a feature map compression processing on the global feature map at spatial dimension to obtain an initial channel attention vector of the global feature map;
performing, by using the first fully connected layer and the ReLU function, a vector dimension incretion processing on the initial channel attention vector at channel dimension to obtain an intermediate channel attention vector; and
performing, by using the second fully connected layer and the Sigmoid function, a vector dimension reduction processing on the intermediate channel attention vector at channel dimension to obtain the low-order channel attention vector.

14. The storage medium of claim 12, wherein the high-order information learning sub-model includes a feature map expansion module, a similarity matrix creation module and an attention vector extraction module connected in sequence; and wherein obtaining the high-order channel attention vector by learning through driving the high-order information learning sub-model to extract second-order image information of the input global feature map comprises:
performing, by using the feature map expansion module, a feature map expansion processing on the global feature map along a direction of channel dimension to obtain a two-dimensional feature matrix corresponding to the global feature map at channel dimension, wherein each row matrix vector of the two-dimensional feature matrix is for representing image features of the global feature map at a corresponding channel;
calculating, by using the similarity matrix creation module, a vector similarity between row matrix vectors of the two-dimensional feature matrix, and performing a matrix construction based on all the calculated vector similarities to obtain a feature similarity matrix of the global feature map at channel dimension; and
performing, by using the attention vector extraction module, an element mean operation on each column matrix vector of the feature similarity matrix to obtain the high-order channel attention vector composed of an actual element mean of the column matrix vector.

15. The storage medium of claim 11, wherein obtaining the expected feature map of the to-be-identified image by performing the attention vector fusion weighted processing on the global feature map based on the low-order channel attention vector and the high-order channel attention vector comprises:
calculating an average channel attention vector between the low-order channel attention vector and the high-order channel attention vector; and
obtaining the expected feature map by performing a channel-by-channel multiplication operation on the global feature map and the average channel attention vector.
